(19) United States
(12) Patent Application Publication
(10) Pub. No.: US 2025/0233368 A1
(43) Pub. Date: Jul. 17, 2025

(54) ELECTRICAL CONNECTOR

(71) Applicant: CHENG UEI PRECISION INDUSTRY CO., LTD., New Taipei City (TW)

(72) Inventors: ZE-LE HU, Dong-Guan City, Guangdong Province (CN); YU-JIE WU, Dong-Guan City, Guangdong Province (CN); YUN WU, Dong-Guan City, Guangdong Province (CN)

(21) Appl. No.: 18/805,489

(22) Filed: Aug. 14, 2024

(30) Foreign Application Priority Data
Jan. 16, 2024 (CN) 202420112398.7

(51) Int. Cl. H01R 13/6585; H01R 13/6582

(52) U.S. Cl. CPC H01R 13/6585; H01R 13/6582

(57) ABSTRACT

An electrical connector includes an insulation body, a terminal assembly fastened in the insulation body, a middle grounding plate and a detecting structure. The middle grounding plate is mounted in a middle of the terminal assembly. One side of the middle grounding plate has an elastic arm. The middle grounding plate has a main portion. Two rear ends of two opposite side edges of the main portion transversely extend outward to form two extending portions. A rear end of the elastic arm is connected with one extending portion. The detecting structure is disposed to the other side of the middle grounding plate. The detecting structure is fastened in the insulation body. A front end of the detecting structure is exposed out of the insulation body. The other extending portion is disconnected from a rear end of the detecting structure.

### CROSS REFERENCE TO RELATED APPLICATIONS

The present application is based on, and claims priority from, China Patent Application No. 202420112398.7, filed Jan. 16, 2024, the disclosure of which is hereby incorporated by reference herein in its entirety.

### BACKGROUND OF THE INVENTION

### Field of the Invention

The present invention generally relates to an electrical connector, and more particularly to an electrical connector which is capable of reducing an assembling space and simplifying an assembling process.

### Description of Related Art

In various electrical connector types which are frequently used by various electronic products, universal serial bus (USB) connectors are the most widely applied connectors. With the improvement of sciences and technologies, more and more kinds of the universal serial bus connectors are developed, such as USB 2.0, USB 3.0, Micro USB, Mini USB or USB Type-C. The USB Type-C connectors have been widely applied in the various electronic products.

A conventional electrical connector includes an insulating body, a plurality of conductive terminals, a detecting terminal and a first metal shell. The insulating body has an insulating seat and a tongue board. The plurality of the conductive terminals are transversely fastened to the tongue board. The plurality of the conductive terminals are spaced from one another. Rear ends of the plurality of the conductive terminals are exposed out of the insulating seat. The detecting terminal is disposed to an upper portion or a lower portion of the insulating seat. The first metal shell surrounds an outside of the insulating seat. The detecting terminal is spaced from the plurality of the terminals. The detecting terminal keeps a distance from the first metal shell. When an external electrical connector is inserted into the conventional electrical connector, a second metal shell of the external electrical connector is disposed between the tongue board and the first metal shell of the conventional electrical connector. The detecting terminal contacts with the second metal shell of the external electrical connector, so that a corresponding protection mechanism is subsequently activated by detecting the second metal shell of the external electrical connector.

However, the detecting terminal of the conventional electrical connector is disposed to the upper portion or the lower portion of the insulating seat, the conventional electrical connector requires a larger assembling space for receiving the detecting terminal. Moreover, when the conventional electrical connector is manufactured, the detecting terminal of the conventional electrical connector requires an extra assembling process to be manufactured, so the assembling space of the conventional electrical connector is increased, and the assembling process of the conventional electrical connector is complicated.

Thus, it is essential to provide an innovative electrical connector, the electrical connector is capable of reducing an assembling space and simplifying an assembling process.

### BRIEF SUMMARY OF THE INVENTION

An object of the present invention is to provide an electrical connector which is capable of reducing an assembling space and simplifying an assembling process. The electrical connector includes an insulation body, a terminal assembly fastened in the insulation body, a middle grounding plate and a detecting structure. The middle grounding plate is mounted in a middle of the terminal assembly. One side of the middle grounding plate is exposed out of the terminal assembly. The middle grounding plate is fastened in the insulation body. The one side of the middle grounding plate has an elastic arm. A front end of the elastic arm is exposed out of a front surface of the insulation body. The middle grounding plate has a main portion. Two rear ends of two opposite side edges of the main portion transversely extend outward to form two extending portions. A rear end of the elastic arm is connected with one extending portion. The detecting structure is disposed to the other side of the middle grounding plate. The detecting structure is fastened in the insulation body. A front end of the detecting structure is exposed out of the front surface of the insulation body. A rear end of the detecting structure is corresponding to the other extending portion. The other extending portion is disconnected from the rear end of the detecting structure to form a gap between the rear end of the detecting structure and the other extending portion.

Another object of the present invention is to provide an electrical connector. The electrical connector includes an insulation body, a terminal assembly fastened in the insulation body, and a middle grounding plate mounted in a middle of the terminal assembly. The middle grounding plate is fastened in the insulation body. The middle grounding plate has a main portion. Two rear ends of two opposite side edges of the main portion transversely extend outward to form two extending portions. Two middles of the two opposite side edges of the main portion transversely extend outward to form two wings. The two middles of the two opposite side edges of the main portion protrude outward, and then are bent upward to form two bending portions. Two opposite sides of a rear end of the main portion have two arms. One extending portion is connected with a rear end of the one arm. The other extending portion faces towards a rear end of the other arm. The other extending portion is disconnected from the rear end of the other arm. A gap is formed between the other arm and the other extending portion. The one arm is defined as an elastic arm of the middle grounding plate. The other arm is defined as a detecting structure. The elastic arm has a first base plate, a first surrounding portion, a resilient arm and a first contacting portion. An outer end of the one extending portion extends frontward to form the first base plate. A front end of the first base plate extends frontward to form the first surrounding portion. The first surrounding portion is surrounded by the insulation body. A front end of the first surrounding portion extends frontward and then is bent inward to form the resilient arm. The resilient arm extends out of a front surface of the insulation body. A front end of the resilient arm is bent outward, and then slantwise extends outward and frontward to form the first contacting portion. The detecting structure is fastened in the insulation body. The detecting structure has a second base plate, a second surrounding portion, a flexible arm and a second contacting portion. The second base plate and the first base plate are corresponding to two outer ends of the two extending portions, respectively. A front end of the second base plate extends frontward to form the second surrounding portion. The second surrounding portion is surrounded by the insulation body. The second surrounding portion and the first surrounding portion are corresponding to two outer sides of the two wings. A front end of the second surrounding portion extends frontward and is bent inward to form the flexible arm. The flexible arm extends out of the front surface of the insulation body. The flexible arm and the resilient arm are corresponding to the two bending portions. A front end of the flexible arm is bent outward, and then slantwise extends frontward and outward to form the second contacting portion. A position of the first contacting portion is located in front of a position of the second contacting portion. An outer side of a rear end of the second base plate has a soldering foot.

Another object of the present invention is to provide an electrical connector. The electrical connector includes an insulation body, a terminal assembly fastened in the insulation body and a middle grounding plate. The middle grounding plate mounted in a middle of the terminal assembly. The middle grounding plate is fastened in the insulation body. The middle grounding plate is made of a metal foil to form one piece with a main portion. A pair of extending portions extended from two rear ends of opposite side edges of the main portion. A pair of arms extended from the extending portions and positioned at opposite sides of the main body. One of the extending portions is cut off to make one of the arms to be separated from the main portion. A separated arm is formed as a detecting structure. The detecting structure has a soldering foot. The arm without the soldering foot connects the extending portion.

As described above, the detecting structure and the elastic arm of the middle grounding plate are simultaneously formed by a stamping procedure, and then a connecting slice is cut off to form the gap between the detecting structure and the middle grounding plate by a cutting procedure, the detecting structure of the electrical connector is without increasing an extra manufacturing process and an extra assembling process, so the electrical connector is capable of simplifying the assembling process. Furthermore, the detecting structure and the elastic arm are formed to two opposite sides of the middle grounding plate, so the electrical connector has an innovative structure design, and an assembling space of the electrical connector is decreased. In addition, when the electrical connector is docked with a docking connector, the first contacting portion of the elastic arm of the middle grounding plate contacts with a shell of the docking connector, and then the second contacting portion of the detecting structure contacts with the shell of the docking connector, so a usage life of the detecting structure is increased. As a result, the electrical connector is capable of reducing the assembling space and simplifying the assembling process.

### BRIEF DESCRIPTION OF THE DRAWINGS

The present invention will be apparent to those skilled in the art by reading the following description, with reference to the attached drawings, in which:

FIG. 1 is a perspective view of an electrical connector in accordance with the present invention;

FIG. 2 is a partially exploded view showing a glue body, an insulating housing, a metal shell assembly, and an insulation body together with a terminal assembly, a middle grounding plate, two shielding plates and a detecting structure of the electrical connector of FIG. 1;

FIG. 3 is another partially exploded view showing the insulation body, the two shielding plates, and the terminal assembly together with the middle grounding plate and the detecting structure of the electrical connector of FIG. 1;

FIG. 4 is a perspective view of the middle grounding plate and the detecting structure of the electrical connector of FIG. 1;

FIG. 5 is a partial assembling view of the electrical connector of FIG. 1;

FIG. 6 is a diagrammatic drawing of the electrical connector of FIG. 1;

FIG. 7 is a sectional view of the electrical connector along a line VII-VII of FIG. 6;

FIG. 8 is an enlarged view of an encircled portion VIII of the electrical connector of FIG. 7;

FIG. 9 is an assembling view of the insulation body and the detecting structure of the electrical connector of FIG. 1; and

FIG. 10 is a perspective view of the detecting structure of the electrical connector of FIG. 1.

### DETAILED DESCRIPTION OF THE INVENTION

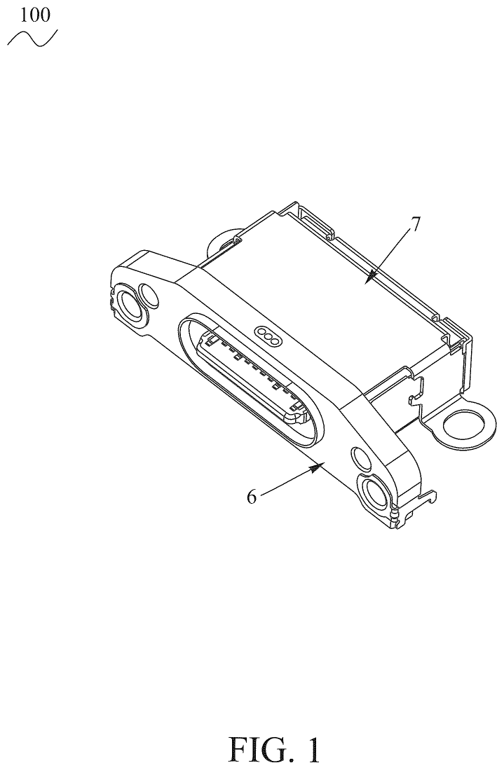

With reference to FIG. 1 to FIG. 3, an electrical connector 100 in accordance with the present invention is shown. The electrical connector 100 includes an insulation body 1, a terminal assembly 2, a middle grounding plate 3, two shielding plates 4, a glue body 5, an insulating housing 6, a metal shell assembly 7 and a detecting structure 8. In the present invention, the electrical connector 100 is a USB (Universal Serial Bus) Type-C connector. In a concrete implementation, the electrical connector 100 is able to be another type connector which is different from the USB Type-C connector.

The middle grounding plate 3 is mounted in a middle of the terminal assembly 2, and one side of the middle grounding plate 3 is exposed out of the terminal assembly 2. The detecting structure 8 is disposed to the other side of the middle grounding plate 3. The detecting structure 8 is exposed out of the terminal assembly 2. The terminal assembly 2 is located between the one side of the middle grounding plate 3 and the detecting structure 8. The terminal assembly 2, the middle grounding plate 3 and the detecting structure 8 are fastened in the insulation body 1. The insulation body 1 surrounds the middle grounding plate 3 and the terminal assembly 2. The two shielding plates 4 are disposed to an upper portion and a lower portion of the insulation body 1. The insulation body 1 is fastened in the insulating housing 6. The metal shell assembly 7 is disposed to a top surface and a bottom surface of the insulating housing 6. A rear end of the middle grounding plate 3 is connected with a rear end of the metal shell assembly 7. The metal shell assembly 7 is used for grounding and shielding an interference.

The glue body 5 surrounds a rear end of the insulation body 1. The glue body 5 is covered to a rear end of the insulating housing 6. The glue body 5 seals up a gap between the insulation body 1 and the insulating housing 6, so water is prevented from flowing into a rear end of the electrical connector 100, and the electrical connector 100 is prevented from being damaged. The glue body 5 surrounds a part of the terminal assembly 2 and a part of the middle grounding plate 3.

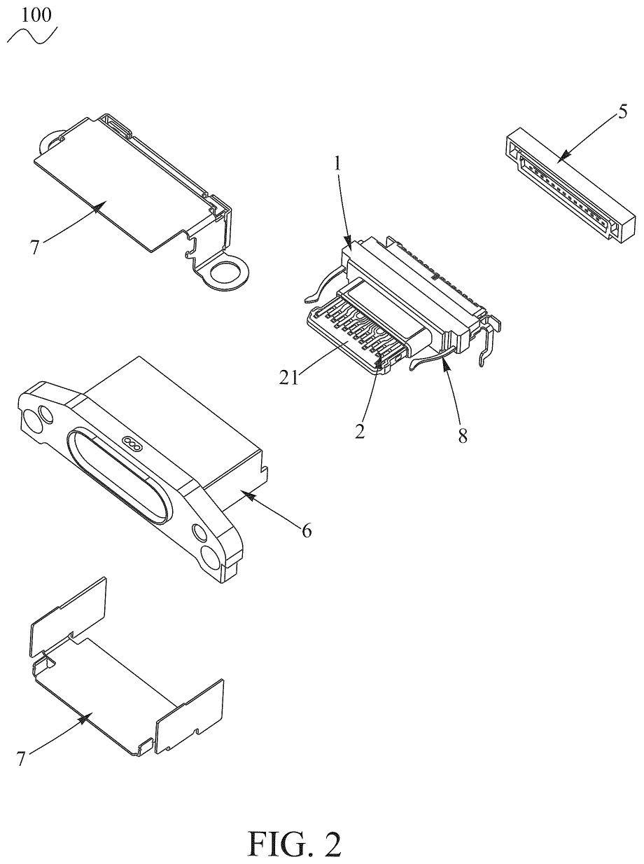

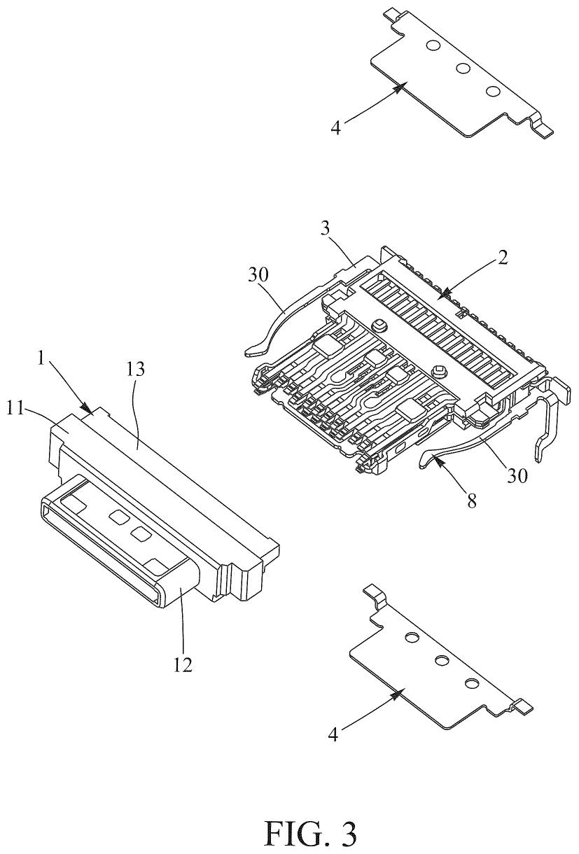

Referring to FIG. 2 and FIG. 3, the insulation body 1 has a base body 11, a stepping portion 12 and a tail portion 13. A middle of a front surface of the base body 11 extends frontward to form the stepping portion 12. The stepping portion 12 is a hollow structure. A middle of a rear surface of the base body 11 extends rearward to form the tail portion 13. The tail portion 13 surrounds a corresponding structure of the detecting structure 8. A front end of the terminal assembly 2 has a tongue portion 21. The tongue portion 21 is disposed to a front end of the stepping portion 12 of the insulation body 1. The tongue portion 21 is exposed out of a front surface of the stepping portion 12 of the insulation body 1.

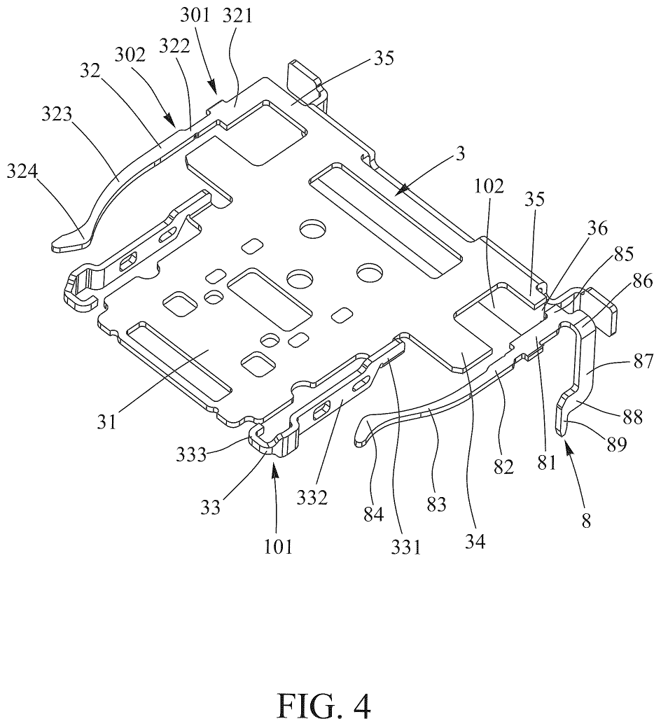

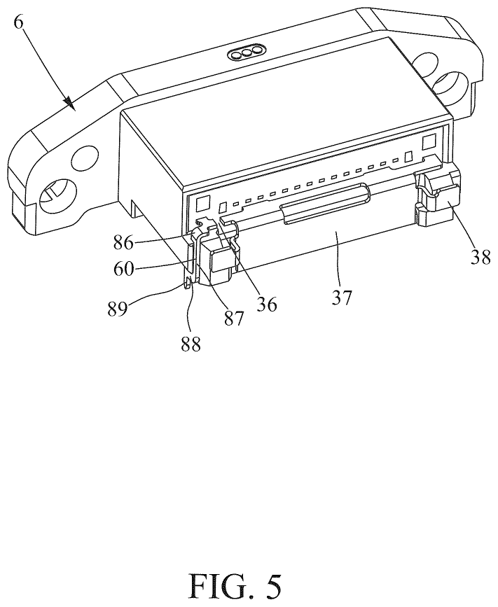

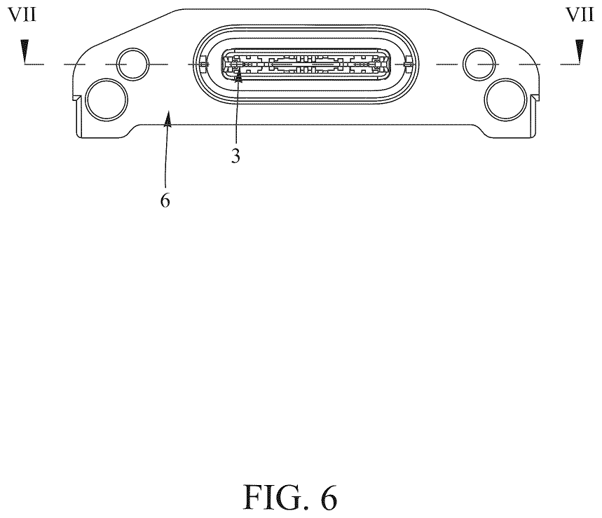

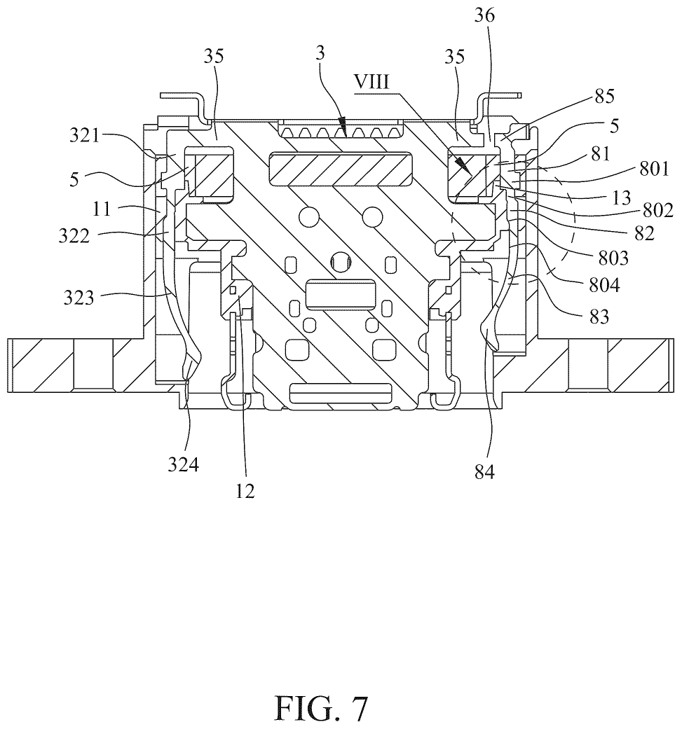

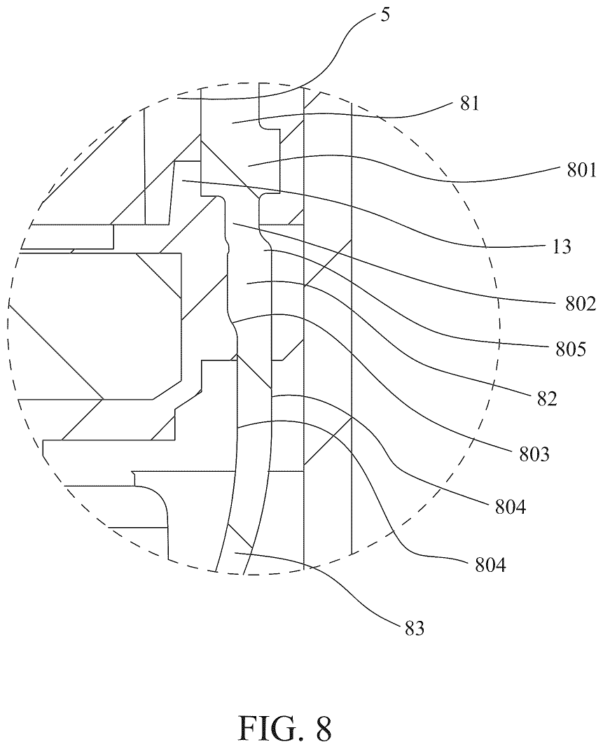

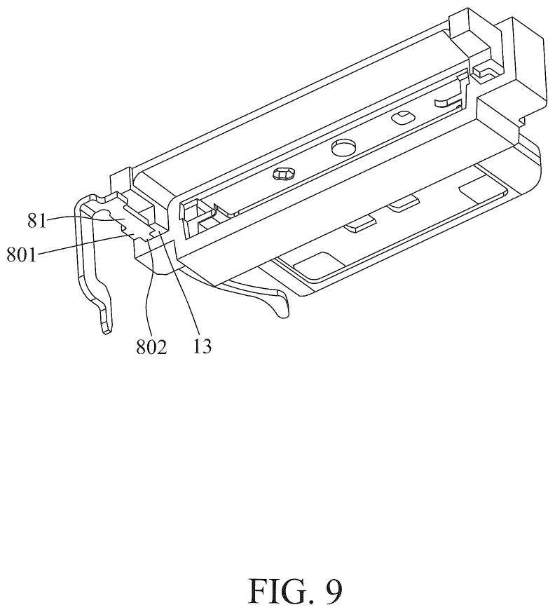

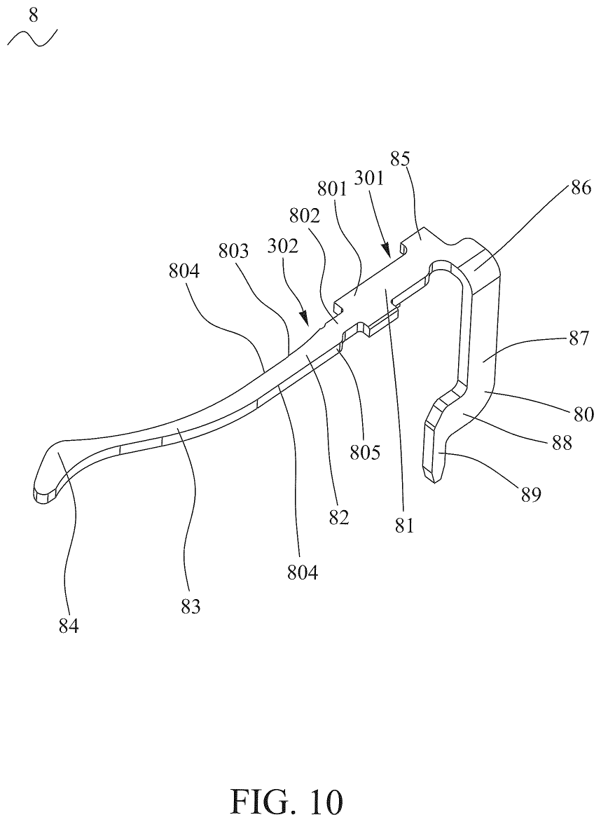

Referring to FIG. 4 to FIG. 10, the electrical connector 100 further includes a middle plate assembly 101. The middle plate assembly 101 is mounted in the middle of the terminal assembly 2. The middle plate assembly 101 includes the middle grounding plate 3, the detecting structure 8 disconnected from the middle grounding plate 3, and a gap 36 formed between the middle grounding plate 3 and the detecting structure 8. The middle grounding plate 3 has a main portion 31, an elastic arm 32, two bending portions 33, two wings 34, two extending portions 35, an isolating plate 37 and two soldering portions 38. The one side of the middle grounding plate 3 has the elastic arm 32. One side of the main portion 31 has the elastic arm 32. A front end of the elastic arm 32 is exposed out of a front surface of the insulation body 1. The detecting structure 8 is positioned adjacent to the other side of the middle grounding plate 3. The detecting structure 8 is positioned adjacent to the other side of main portion 31. A front end of the detecting structure 8 is exposed out of the front surface of the insulation body 1. The detecting structure 8 is disconnected from the other side of the middle grounding plate 3. Two opposite sides of a rear end of the main portion 31 have two arms 30 extending frontward, respectively.

The detecting structure 8 is spaced from the other side of the middle grounding plate 3 to form the gap 36 between the detecting structure 8 and the other side of the middle grounding plate 3. The middle plate assembly 101 is separated into the middle grounding plate 3 and the detecting structure 8 by the gap 36. One arm 30 is connected with the one side of the main portion 31, and the one arm 30 is defined as the elastic arm 32 of the middle grounding plate 3. The other arm 30 is positioned adjacent to the other side of the main portion 31, the other arm 30 is disconnected from the main portion 31 of the middle grounding plate 3 by the gap 36, and the other arm 30 is defined as the detecting structure 8. The elastic arm 32 is connected with the one side of the main portion 31. The gap 36 is formed between the main portion 31 and the detecting structure 8. The elastic arm 32 is used for being connected to ground. The elastic arm 32 and the detecting structure 8 are contacted with two opposite sides of a shell (not shown) of a docking connector (not shown), respectively. The detecting structure 8 is used for detecting whether the electrical connector 100 contacts with the docking connector successfully.

A right side of the middle grounding plate 3 has the elastic arm 32. A left side of the middle grounding plate 3 is positioned adjacent to the detecting structure 8. In a concrete implementation, the elastic arm 32 is without being limited to be located at the right side of the middle grounding plate 3. The detecting structure 8 is without being limited to be positioned adjacent to the left side of the middle grounding plate 3.

Each arm 30 has a base plate 301 and a surrounding portion 302, so the elastic arm 32 has the base plate 301 and the surrounding portion 302, and detecting structure 8 has the base plate 301 and the surrounding portion 302. The base plate 301 is surrounded by the glue body 5. A middle of a front end of the base plate 301 extends frontward to form the surrounding portion 302. The surrounding portion 302 is surrounded by the base body 11 of the insulation body 1. The front end of the base plate 301 is formed as a fixing piece 801 extended frontward and outward from a rear end of the base plate 301. An inner surface and a top surface of the fixing piece 801 are partially surrounded by the tail portion 13 of the insulation body 1. A middle of a front surface of the fixing piece 801 extends frontward to form a fixing bar 802. The fixing bar 802 is formed at a rear end of the surrounding portion 302. The fixing bar 802 is disposed between a front end of the surrounding portion 302 and the fixing piece 801. The fixing bar 802 is exposed out of a rear end of the base body 11 of the insulation body 1. An inner surface and a top surface of the fixing bar 802 is surrounded by the tail portion 13. An inner surface of the front end of the surrounding portion 302 is recessed inward to form an arc portion 803. The arc portion 803 is surrounded by the base body 11 of the insulation body 1. The inner surface of the front end of the surrounding portion 302 extends frontward to form a straight portion 804. A front end of the arc portion 803 extends frontward to form the straight portion 804. An outer surface of the front end of the surrounding portion 302 extends frontward to form the straight portion 804. A rear end of the straight portion 804 is surrounded by the base body 11.

Two middles of two opposite side edges of the main portion 31 protrude outward, and then are bent upward to form the two bending portions 33. The two bending portions 33 are partially surrounded by the stepping portion 12 of the insulation body 1. Two rear ends of the two bending portions 33 are surrounded by the stepping portion 12. Two front ends of the two bending portions 33 are exposed out of the stepping portion 12. The two middles of the two opposite side edges of the main portion 31 transversely extend outward to form the two wings 34. The two bending portions 33 are located in front of the two wings 34. The two wings 34 are surrounded by the base body 11 of the insulation body 1. Two rear ends of the two opposite side edges of the main portion 31 transversely extend outward to form the two extending portions 35. One extending portion 35 is connected with a rear end of the one arm 30. The other extending portion 35 faces towards a rear end of the other arm 30. The other extending portion 35 is disconnected from the rear end of the other arm 30. The gap 36 is formed between the other arm 30 and the other extending portion 35. A rear end of the elastic arm 32 is connected with the one extending portion 35. A rear end of the detecting structure 8 is corresponding to the other extending portion 35. The other extending portion 35 is disconnected from the rear end of the detecting structure 8 to form the gap 36 between the rear end of the detecting structure 8 and the other extending portion 35. The gap 36 is disposed between the rear end of the detecting structure 8 and the other extending portion 35. A rear edge of the main portion 31 is bent downward to form the isolating plate 37. The isolating plate 37 extends out of a rear end of the glue body 5. Two opposite sides of the isolating plate 37 are bent rearward and then are bent outward to form the two soldering portions 38, respectively. The two soldering portions 38 are connected with the metal shell assembly 7.

The elastic arm 32 has a first base plate 321, a first surrounding portion 322, a resilient arm 323 and a first contacting portion 324, so the one arm 30 has the first base plate 321, the first surrounding portion 322, the resilient arm 323 and the first contacting portion 324. The base plate 301 of the elastic arm 32 is the first base plate 321. The surrounding portion 302 of the elastic arm 32 is the first surrounding portion 322. An outer end of the one extending portion 35 extends frontward to form the first base plate 321. The first base plate 321 is located between one wing 34 and the one extending portion 35. The first base plate 321 is surrounded by the glue body 5. A rear end of the first base plate 321 is connected with the outer end of the one extending portion 35. A middle of a front end of the first base plate 321 extends frontward to form the first surrounding portion 322. The first surrounding portion 322 is surrounded by the base body 11 of the insulation body 1. The first surrounding portion 322 is corresponding to the one wing 34 along a transverse direction. A front end of the first surrounding portion 322 extends frontward and then is bent inward to form the resilient arm 323. The resilient arm 323 extends out of the front surface of the base body 11 of the insulation body 1. A front end of the resilient arm 323 is bent outward, and then slantwise extends outward and frontward to form the first contacting portion 324. The first contacting portion 324 is used for contacting the shell (not shown) of the docking connector (not shown).

Each bending portion 33 has a bending section 331, an extending strap 332 and a hook portion 333. The bending section 331 of each bending portion 33 is protruded outward and then is bent upward from the middle of one side edge of the main portion 31. An upper portion of a front end of the bending section 331 slantwise extends frontward and downward, and then extends frontward to form the extending strap 332. A front end of the extending strap 332 is arched outward, then is bent inward and is further bent rearward to form the hook portion 333. The bending section 331 and a rear end of the extending strap 332 are surrounded by the stepping portion 12 of the insulation body 1. The first contacting portion 324 of the elastic arm 32 is corresponding to a front end of the extending strap 332 of one bending portion 33.

Referring to FIG. 1 to FIG. 10, the detecting structure 8 is disposed to the one side of the middle grounding plate 3 for reducing an assembling space of the electrical connector 100. When the electrical connector 100 is docked with the docking connector (not shown), the detecting structure 8 contacts with the shell (not shown) of the docking connector (not shown), and the detecting structure 8 outputs a signal. The detecting structure 8 has a connecting portion 80, a second base plate 81, a second surrounding portion 82, a flexible arm 83, a second contacting portion 84, a protruding portion 85, a curving portion 86 and a soldering foot 89, so the other arm 30 has the connecting portion 80, the second base plate 81, the second surrounding portion 82, the flexible arm 83, the second contacting portion 84, the protruding portion 85, the curving portion 86 and the soldering foot 89. The connecting portion 80 includes a first connecting portion 87 and a second connecting portion 88. An outer side of a rear end of the second base plate 81 has the soldering foot 89. The base plate 301 of the detecting structure 8 is the second base plate 81. The surrounding portion 302 of the detecting structure 8 is the second surrounding portion 82.

The second base plate 81 is located to two outer sides of the other wing 34 and the other extending portion 35 of the middle grounding plate 3. The second base plate 81 is surrounded by the glue body 5. The second base plate 81 and the first base plate 321 of the middle grounding plate 3 are corresponding to two outer ends of the two extending portions 35, respectively. A front end of the second base plate 81 extends frontward to form the second surrounding portion 82. The second surrounding portion 82 is surrounded by the base body 11 of the insulation body 1. The second surrounding portion 82 is corresponding to the other wing 34 along the transverse direction. The second surrounding portion 82 and the first surrounding portion 322 of the middle grounding plate 3 are corresponding to two outer sides of the two wings 34. A front end of the second surrounding portion 82 extends frontward and is bent inward to form the flexible arm 83. The flexible arm 83 extends out of the front surface of the insulation body 1. The flexible arm 83 extends out of the front surface of the base body 11 of the insulation body 1. The flexible arm 83 and the resilient arm 323 of the middle grounding plate 3 are corresponding to the two bending sections 331 of the two bending portions 33. A front end of the flexible arm 83 is bent outward, and then slantwise extends frontward and outward to form the second contacting portion 84. The second contacting portion 84 is corresponding to the extending strap 332 of the other bending portion 33 of the middle grounding plate 3 along the transverse direction. The second contacting portion 84 is used for contacting the shell (not shown) of the docking connector (not shown). A position of the first contacting portion 324 of the elastic arm 32 of the middle grounding plate 3 is located in front of a position of the second contacting portion 84 of the detecting structure 8 along the longitudinal direction.

An inner surface of the rear end of the second base plate 81 extends inward to form the protruding portion 85. The protruding portion 85 is corresponding to the other extending portion 35 of the middle grounding plate 3. The protruding portion 85 is spaced from the other extending portion 35 of the middle grounding plate 3 to form the gap 36 between the protruding portion 85 and the other extending portion 35 of the middle grounding plate 3. In a manufacturing process, the detecting structure 8 and the elastic arm 32 are simultaneously formed to the two opposite sides of the middle grounding plate 3 by a stamping procedure. A connecting slice (not shown) is connected between the detecting structure 8 and the middle grounding plate 3, and then the connecting slice (not shown) is cut off to form the gap 36 between the detecting structure 8 and the middle grounding plate 3 by a cutting procedure, so the detecting structure 8 is separated from the middle grounding plate 3. The stamping procedure and the cutting procedure are base procedures for manufacturing the middle grounding plate 3, and the detecting structure 8 of the electrical connector 100 is without increasing an extra manufacturing process and an extra assembling process, so the electrical connector 100 is capable of simplifying the assembling process.

An outer surface of the rear end of the second base plate 81 is bent downward to form the curving portion 86. A bottom end of the curving portion 86 extends downward to form the connecting portion 80. A front of a bottom end of the connecting portion 80 extends downward to form the soldering foot 89. Specifically, the bottom end of the curving portion 86 extends downward to form the first connecting portion 87. A bottom end of the first connecting portion 87 is bent frontward to form the second connecting portion 88. A front end of the second connecting portion 88 is bent downward to form the soldering foot 89. One side of a rear surface of the insulating housing 6 is recessed frontward to form an inserting slot 60. The connecting portion 80 is inserted in the inserting slot 60 of the insulating housing 6. The first connecting portion 87 is fastened in the inserting slot 60 of the insulating housing 6. The second connecting portion 88 is disposed to a bottom end of the inserting slot 60 of the insulating housing 6. The second connecting portion 88 is attached to a lower portion of a rear end of an outer surface of the insulating housing 6. The soldering foot 89 is fastened in a circuit board (not shown).

The first base plate 321 of the middle grounding plate 3, the first surrounding portion 322 of the middle grounding plate 3, the resilient arm 323 of the middle grounding plate 3, the first contacting portion 324 of the middle grounding plate 3, the second base plate 81, the second surrounding portion 82, the flexible arm 83 and the second contacting portion 84 are disposed in the insulating housing 6. The protruding portion 85, the curving portion 86, the first connecting portion 87, the second connecting portion 88 and the soldering foot 89 are exposed out of the rear end of the insulating housing 6. The protruding portion 85, the curving portion 86, the connecting portion 80 and the soldering foot 89 are exposed out of the rear end of the insulating housing 6.

Referring to FIG. 3 to FIG. 10, the detecting structure 8 has the fixing piece 801 formed at the front end of the second base plate 81, the fixing bar 802 formed at a rear end of the second surrounding portion 82, the arc portion 803, the straight portion 804, and a protruding block 805 formed at the front end of the second surrounding portion 82. A rear end of the second base plate 81 extends frontward and outward to form the fixing piece 801. The inner surface and the top surface of the fixing piece 801 are partially surrounded by the tail portion 13 of the insulation body 1 to realize that the detecting structure 8 is located to the insulation body 1, and the detecting structure 8 is fastened to the insulation body 1. The fixing piece 801 is located to an outer side of an interval 102 between the other wing 34 and the other extending portion 35.

A middle of a front end of the fixing piece 801 of the detecting structure 8 extends frontward to form the fixing bar 802. The fixing bar 802 of the detecting structure 8 is disposed between the front end of the second surrounding portion 82 of the detecting structure 8 and the fixing piece 801 of the detecting structure 8. A width of the fixing bar 802 is narrower than a width of the fixing piece 801 and a width of the front end of the second surrounding portion 82. The fixing bar 802 of the detecting structure 8 is exposed out of the rear end of the base body 11 of the insulation body 1. The inner surface and the top surface of the fixing bar 802 of the detecting structure 8 is surrounded by the tail portion 13 to realize that the detecting structure 8 is located to the insulation body 1, and the detecting structure 8 is fastened to the insulation body 1.

An outer side of a front end of the fixing bar 802 is arched outward and extends frontward to form the protruding block 805. A rear end of the protruding block 805 is connected with the front end of the fixing bar 802. A width of the protruding block 805 is wider than the width of the fixing bar 802. An inner surface of the protruding block 805 of the second surrounding portion 82 is recessed inward to form the arc portion 803. An inner surface of the rear end of the second surrounding portion 82 is smoother than an inner surface of the front end of the second surrounding portion 82 on account of the arc portion 803 of the protruding block 805 which is formed at the front end of the second surrounding portion 82. The detecting structure 8 is difficult to be damaged. A usage life of the electrical connector 100 is increased. An occupying space of the protruding block 805 of the second surrounding portion 82 is reduced by the arc portion 803. A distance between the second surrounding portion 82 and a mold (not shown) is increased, so that a damage of the detecting structure 8 and the mold (not shown) is prevented.

The arc portion 803 of the detecting structure 8 is surrounded by the base body 11 of the insulation body 1. A front end of the arc portion 803 of the detecting structure 8 extends frontward to form the straight portion 804. The inner surface of the front end of the second surrounding portion 82 extends frontward to form the straight portion 804. An outer surface of the front end of the second surrounding portion 82 extends frontward to form the straight portion 804. The straight portion 804 of the detecting structure 8 is disposed to the front end of the second surrounding portion 82 to be convenient for a glue sealing process. A rear end of the straight portion 804 of the detecting structure 8 is surrounded by the base body 11 of the insulation body 1.

A length of the detecting structure 8 is shorter than a length of the elastic arm 32 of the middle grounding plate 3 along a longitudinal direction. A curvature of the detecting structure 8 is larger than a curvature of the elastic arm 32 of the middle grounding plate 3. When the electrical connector 100 is docked with the docking connector (not shown), the first contacting portion 324 of the elastic arm 32 of the middle grounding plate 3 contacts with the shell (not shown) of the docking connector (not shown), and then the second contacting portion 84 of the detecting structure 8 contacts with the shell (not shown) of the docking connector (not shown), so a usage life of the detecting structure 8 is increased. Specifically, a length of the flexible arm 83 of the detecting structure 8 is shorter than a length of the resilient arm 323 of the elastic arm 32 of the middle grounding plate 3 along the longitudinal direction. A curvature of the flexible arm 83 is larger than a curvature of the resilient arm 323 of the elastic arm 32 of the middle grounding plate 3.

As described above, the detecting structure 8 and the elastic arm 32 of the middle grounding plate 3 are simultaneously formed by the stamping procedure, and then the connecting slice is cut off to form the gap 36 between the detecting structure 8 and the middle grounding plate 3 by the cutting procedure, the detecting structure 8 of the electrical connector 100 is without increasing the extra manufacturing process and the extra assembling process, so the electrical connector 100 is capable of simplifying the assembling process. Furthermore, the detecting structure 8 and the elastic arm 32 are formed to the two opposite sides of the middle grounding plate 3, so the electrical connector 100 has an innovative structure design, and the assembling space of the electrical connector 100 is decreased. In addition, when the electrical connector 100 is docked with the docking connector, the first contacting portion 324 of the elastic arm 32 of the middle grounding plate 3 contacts with the shell of the docking connector, and then the second contacting portion 84 of the detecting structure 8 contacts with the shell of the docking connector, so the usage life of the detecting structure 8 is increased. As a result, the electrical connector 100 is capable of reducing the assembling space and simplifying the assembling process.

What is claimed is:

1. An electrical connector, comprising:
an insulating body;
a terminal assembly fastened in the insulation body;
a middle grounding plate mounted in a middle of the terminal assembly, one side of the middle grounding plate being exposed out of the terminal assembly, the middle grounding plate being fastened in the insulation body, the one side of the middle grounding plate having an elastic arm, a front end of the elastic arm being exposed out of a front surface of the insulation body, the middle grounding plate having a main portion, two rear ends of two opposite side edges of the main portion transversely extending outward to form two extending portions, a rear end of the elastic arm being connected with one extending portion; and
a detecting structure disposed to the other side of the middle grounding plate, the detecting structure being fastened in the insulation body, a front end of the detecting structure being exposed out of the front surface of the insulation body, a rear end of the detecting structure being corresponding to the other extending portion, the other extending portion being disconnected from the rear end of the detecting structure to form a gap between the rear end of the detecting structure and the other extending portion.

2. The electrical connector as claimed in claim 1, wherein a length of the detecting structure is shorter than a length of the elastic arm of the middle grounding plate.

3. The electrical connector as claimed in claim 1, wherein a curvature of the detecting structure is larger than a curvature of the elastic arm of the middle grounding plate.

4. The electrical connector as claimed in claim 1, wherein the elastic arm has a first base plate, a first surrounding portion, a resilient arm and a first contacting portion, an outer end of the one extending portion extends frontward to form the first base plate, a rear end of the first base plate is connected with the outer end of the one extending portion, a middle of a front end of the first base plate extends frontward to form the first surrounding portion, a front end of the first surrounding portion extends frontward and then is bent inward to form the resilient arm, a front end of the resilient arm is bent outward, and then slantwise extends outward and frontward to form the first contacting portion, the first surrounding portion is surrounded by the insulation body, the resilient arm extends out of the front surface of the insulation body.

5. The electrical connector as claimed in claim 4, wherein the detecting structure has a second base plate, a second surrounding portion, a flexible arm and a second contacting portion, a front end of the second base plate extends frontward to form the second surrounding portion, a front end of the second surrounding portion extends frontward and is bent inward to form the flexible arm, a front end of the flexible arm is bent outward, and then slantwise extends frontward and outward to form the second contacting portion, the second surrounding portion is surrounded by the insulation body, the flexible arm extends out of the front surface of the insulation body.

6. The electrical connector as claimed in claim 5, wherein a length of the flexible arm of the detecting structure is shorter than a length of the resilient arm of the elastic arm of the middle grounding plate.

7. The electrical connector as claimed in claim 5, wherein an inner surface of a rear end of the second base plate extends inward to form a protruding portion, the protruding portion is corresponding to the other extending portion of the middle grounding plate, the protruding portion is spaced from the other extending portion of the middle grounding plate to form the gap between the protruding portion and the other extending portion of the middle grounding plate.

8. The electrical connector as claimed in claim 7, further comprising an insulating housing, the insulation body being fastened in the insulating housing, an outer surface of a rear end of the second base plate being bent downward to form a curving portion, a bottom end of the curving portion extending downward to form a connecting portion, a front of a bottom end of the connecting portion extending downward to form a soldering foot, one side of a rear surface of the insulating housing being recessed frontward to form an inserting slot, the connecting portion being inserted in the inserting slot.

9. The electrical connector as claimed in claim 8, wherein the connecting portion includes a first connecting portion and a second connecting portion, the bottom end of the curving portion extends downward to form the first connecting portion, a bottom end of the first connecting portion is bent frontward to form the second connecting portion, a front end of the second connecting portion is bent downward to form the soldering foot, the first connecting portion is fastened in the inserting slot, the second connecting portion is disposed to a bottom end of the inserting slot, the second connecting portion is attached to a lower portion of a rear end of an outer surface of the insulating housing.

10. The electrical connector as claimed in claim 8, wherein the first base plate, the first surrounding portion, the resilient arm, the first contacting portion, the second base plate, the second surrounding portion, the flexible arm and the second contacting portion are disposed in the insulating housing, the protruding portion, the curving portion, the connecting portion and the soldering foot are exposed out of a rear end of the insulating housing.

11. The electrical connector as claimed in claim 5, wherein the insulation body has a base body, a middle of a front surface of the base body extends frontward to form a stepping portion, the stepping portion is a hollow structure, a middle of a rear surface of the base body extends rearward to form a tail portion, a front end of the terminal assembly has a tongue portion, the tongue portion is disposed to a front end of the stepping portion, the tongue portion is exposed out of a front surface of the stepping portion, the first surrounding portion is surrounded by the base body, the resilient arm extends out of the front surface of the base body, the second surrounding portion is surrounded by the base body, the flexible arm extends out of the front surface of the base body.

12. The electrical connector as claimed in claim 11, wherein two middles of the two opposite side edges of the main portion protrude outward, and then are bent upward to form two bending portions, the two bending portions are partially surrounded by the stepping portion, the two middles of the two opposite side edges of the main portion transversely extend outward to form two wings, the two bending portions are located in front of the two wings, the two wings are surrounded by the base body, the first base plate is located between one wing and the one extending portion, the first surrounding portion is corresponding to the one wing along a transverse direction, the second base plate is located to two outer sides of the other wing and the other extending portion, the second surrounding portion is corresponding to the other wing along the transverse direction.

13. The electrical connector as claimed in claim 12, wherein a rear end of the second base plate extends frontward and outward to form a fixing piece, an inner surface and a top surface of the fixing piece are partially surrounded by the tail portion of the insulation body, the fixing piece is located to an outer side of an interval between the other wing and the other extending portion, a middle of a front end of the fixing piece extends frontward to form a fixing bar, the fixing bar is disposed between the front end of the second surrounding portion and the fixing piece, a width of the fixing bar is narrower than a width of the fixing piece and a width of the front end of the second surrounding portion, the fixing bar is exposed out of a rear end of the base body, an inner surface and a top surface of the fixing bar are surrounded by the tail portion.

14. The electrical connector as claimed in claim 13, wherein an outer side of a front end of the fixing bar is arched outward and extends frontward to form a protruding block, a width of the protruding block is wider than the width of the fixing bar, an inner surface of the protruding block is recessed inward to form an arc portion, the arc portion is surrounded by the base body, a front end of the arc portion extends frontward to form a straight portion, an outer surface of the front end of the second surrounding portion extends frontward to form the straight portion, the straight portion is disposed to the front end of the second surrounding portion, a rear end of the straight portion is surrounded by the base body of the insulation body.

15. An electrical connector, comprising:
an insulation body;
a terminal assembly fastened in the insulation body; and
a middle grounding plate mounted in a middle of the terminal assembly, the middle grounding plate being fastened in the insulation body, the middle grounding plate having a main portion, two rear ends of two opposite side edges of the main portion transversely extending outward to form two extending portions, two middles of the two opposite side edges of the main portion transversely extending outward to form two wings, the two middles of the two opposite side edges of the main portion protruding outward, and then being bent upward to form two bending portions, two opposite sides of a rear end of the main portion having two arms, one extending portion being connected with a rear end of the one arm, the other extending portion facing towards a rear end of the other arm, the other extending portion being disconnected from the rear end of the other arm, a gap being formed between the other arm and the other extending portion, the one arm being defined as an elastic arm of the middle grounding plate, the other arm being defined as a detecting structure;
wherein the elastic arm has a first base plate, a first surrounding portion, a resilient arm and a first contacting portion, an outer end of the one extending portion extends frontward to form the first base plate, a front end of the first base plate extends frontward to form the first surrounding portion, the first surrounding portion is surrounded by the insulation body, a front end of the first surrounding portion extends frontward and then is bent inward to form the resilient arm, the resilient arm extends out of a front surface of the insulation body, a front end of the resilient arm is bent outward, and then slantwise extends outward and frontward to form the first contacting portion; and
wherein the detecting structure is fastened in the insulation body, the detecting structure has a second base plate, a second surrounding portion, a flexible arm and a second contacting portion, the second base plate and the first base plate are corresponding to two outer ends of the two extending portions, respectively, a front end of the second base plate extends frontward to form the second surrounding portion, the second surrounding portion is surrounded by the insulation body, the second surrounding portion and the first surrounding portion are corresponding to two outer sides of the two wings, a front end of the second surrounding portion extends frontward and is bent inward to form the flexible arm, the flexible arm extends out of the front surface of the insulation body, the flexible arm and the resilient arm are corresponding to the two bending portions, a front end of the flexible arm is bent outward, and then slantwise extends frontward and outward to form the second contacting portion, a position of the first contacting portion is located in front of a position of the second contacting portion, an outer side of a rear end of the second base plate has a soldering foot.

16. The electrical connector as claimed in claim 15, wherein an inner surface of the rear end of the second base plate extends inward to form a protruding portion, the protruding portion is corresponding to the other extending portion of the middle grounding plate, the protruding portion is spaced from the other extending portion of the middle grounding plate to form the gap between the protruding portion and the other extending portion of the middle grounding plate.

17. The electrical connector as claimed in claim 15, further comprising an insulating housing, the insulation body being fastened in the insulating housing, an outer surface of the rear end of the second base plate being bent downward to form a curving portion, a bottom end of the curving portion extending downward to form a connecting portion, a front of a bottom end of the connecting portion extending downward to form the soldering foot, one side of a rear surface of the insulating housing being recessed frontward to form an inserting slot, the connecting portion being inserted in the inserting slot.

18. The electrical connector as claimed in claim 17, wherein the connecting portion includes a first connecting portion and a second connecting portion, the bottom end of the curving portion extends downward to form the first connecting portion, a bottom end of the first connecting portion is bent frontward to form the second connecting portion, a front end of the second connecting portion is bent downward to form the soldering foot, the first connecting portion is fastened in the inserting slot, the second connecting portion is disposed to a bottom end of the inserting slot, the second connecting portion is attached to a lower portion of a rear end of an outer surface of the insulating housing.

19. The electrical connector as claimed in claim 17, wherein the first base plate, the first surrounding portion, the resilient arm, the first contacting portion, the second base plate, the second surrounding portion, the flexible arm and the second contacting portion are disposed in the insulating housing, the protruding portion, the curving portion, the connecting portion and the soldering foot are exposed out of a rear end of the insulating housing.

20. An electrical connector, comprising:
an insulation body;
a terminal assembly fastened in the insulation body; and
a middle grounding plate mounted in a middle of the terminal assembly, the middle grounding plate being fastened in the insulation body;
wherein the middle grounding plate is made of a metal foil to form one piece with a main portion, a pair of extending portions extended from two rear ends of opposite side edges of the main portion, a pair of arms extended from the extending portions and positioned at opposite sides of the main body;
wherein one of the extending portions is cut off to make one of the arms to be separated from the main portion, a separated arm is formed as a detecting structure, the detecting structure has a soldering foot, the arm without the soldering foot connects the extending portion.
